(19) United States
(12) Patent Application Publication
(10) Pub. No.: US 2007/0095037 A1
(43) Pub. Date: May 3, 2007

(54) Supplementary air filter and retainer

(76) Inventor: Samuel B. McLamb III, Arden, NC (US)

Correspondence Address: STEVEN C. SCHNEDLER;CARTER SCHNEDLER & MONTEITH, PA, 56 CENTRAL AVE., SUITE 101, PO BOX 2985, ASHEVILLE, NC, 28802, US

(21) Appl. No.: 11/655,808

(22) Filed: Jan. 18, 2007

(51) Int. Cl. B01D 46/00

(52) U.S. Cl. 55/495

(57) ABSTRACT

Retainers which facilitate the use of a supplementary filter medium, such as activated carbon for removing odors, as well as supplementary filters, in combination with conventional air particulate filter elements in an existing HVAC system, without modification to the HVAC system. Retainers and supplementary filters include a frame-like planar flange having outer edges defining a rectangle sized to match the rectangular air particulate filter element, and are assembled in a sandwich-like configuration with the air particulate filter element. The sandwich-like configuration has rectangular dimensions substantially identical to that of the air particulate filter element, but an increased thickness. However, it is the combined thickness of the air particulate filter element and the planar flange only of the retainer or supplementary filter which is required to be accommodated by a filter mount, and not the entire thickness of the supplementary filter medium.

### BACKGROUND OF THE INVENTION

The invention relates generally to air filters for forced-air heating, ventilation and air conditioning (HVAC) systems and, more particularly, to supplementary gas adsorption or absorption filters, such as filters including activated carbon, for removing odors and chemicals from indoor air.

Forced-air HVAC systems conventionally include air filters. Most common are air particulate filters including a filter medium, which typically is either a woven glass fiber mat, or pleated paper or other sheet-type medium material. In residential systems, a filter element is formed in a rectangular shape nominally one inch in thickness, and includes, in addition to the filter medium, a paperboard frame forming the periphery of the filter element as a support structure. Such filter elements for residential systems are available in a variety of more or less standard sizes, having dimensions of the order of two feet. HVAC systems thus include one or more filter mounts for receiving and holding the air filter element, located typically, but not necessarily, at the air intake opening of an air handler including a blower.

For removing odors and chemicals from indoor air, filter elements are known which include a gas adsorbent or absorbent material, such as activated carbon, bonded to and supported by a substrate such as a porous (open cell) foam material, or, particularly in the case of a pleated filter, a sheet-like substrate of non-woven fibers.

To avoid prematurely clogging the activated carbon filter, combination filters are also known, which include an upstream air particulate filter and a downstream activated carbon filter.

### SUMMARY OF THE INVENTION

In one aspect, a retainer for a supplementary filter medium is provided for use within a filter mount within a forced-air heating and/or ventilation and/or air conditioning system in combination with a conventional air particulate filter element of the type which is rectangular and which has an upstream side and a downstream side. The retainer includes a frame-like planar flange having an upstream side and a downstream side, and having outer edges defining a rectangle sized to match the rectangular conventional air filter element, the frame-like planar flange defining a central opening for air flow; and a retaining structure for the supplementary filter medium extending from the downstream side of the frame-like planar flange adjacent the opening. The upstream side of the frame-like planar flange is positionable facing the downstream side of the conventional air particulate filter element within the filter mount.

In another aspect, a supplementary filter is provided for use within a filter mount within a forced-air heating and/or ventilation and/or air conditioning system in combination with a conventional air particulate filter element of the type which is rectangular which has an upstream side and a downstream side. The supplementary filter includes a supplementary filter medium formed to fit within a hexahedral volume defined by two opposed rectangular major sides and four edge sides establishing a thickness of the hexahedral volume, the supplementary filter medium having an upstream side and a downstream side; and a retainer for the supplementary filter medium. The retainer in turn includes a frame-like planar flange having an upstream side and a downstream side, and having outer edges defining a rectangle sized to match the rectangular air particulate filter element, the frame-like planar flange defining a central opening for air flow, and a retaining structure for the supplementary filter medium extending from the downstream side of the frame-like planar flange adjacent the opening. The upstream side of the supplementary filter medium and the upstream side of the frame-like planar flange are positionable facing the downstream side of the conventional air particulate filter element with the supplementary filter medium retained by the retainer within the filter mount.

In yet another aspect, a supplementary filter is provided for use within a filter mount within a forced-air heating and/or ventilation and/or air conditioning system in combination with a conventional air particulate filter element of the type which is rectangular and which has an upstream side and a downstream side. The supplementary filter includes a supplementary filter element including a supplementary filter medium formed to fit within a hexahedral volume defined by two opposed rectangular major sides and four edge sides establishing a thickness of the hexahedral volume, and a frame forming the periphery of the supplementary filter element as a support structure, the supplementary filter element having an upstream side and a downstream side; and a frame-like planar flange having an upstream side and a downstream side and attached to the frame generally on the upstream side of the supplementary filter element, the frame-like planar flange having outer edges defining a rectangle sized to match the rectangular air particulate filter element, and the frame-like planar flange defining a central opening for air flow. The upstream side of the supplementary filter element and the upstream side of the frame-like planar flange are positionable facing the downstream side of the conventional air particulate filter element with the supplementary filter element retained by the frame-like planar flange within the filter mount.

### BRIEF DESCRIPTION OF THE DRAWINGS

FIG. 1 is an exploded three-dimensional view of a supplementary filter medium and a retainer therefor in combination with a conventional air particulate filter element in a filter mount within a representative part of an HVAC system, the retainer including a retaining grid;

FIG. 2 is a three-dimensional view of the supplementary filter medium and retainer therefor of FIG. 1 in isolation, viewed from the upstream side thereof;

FIG. 3 is a three-dimensional view of the supplementary filter medium and retainer therefor of FIG. 1 in isolation, viewed from the downstream side thereof;

FIG. 4 is an exploded three-dimensional view of a supplementary filter medium and a retainer therefor similar to that of FIG. 1, but showing a frame forming the periphery of the supplementary filter medium as a support structure to define a supplementary filter element, and inwardly-projecting flanges instead of a retaining grid to retain the supplementary filter element;

FIG. 5 is an exploded three-dimensional view of a supplementary filter medium and a retainer therefor nearly identical to that of FIG. 4, but showing a supplementary filter medium comprising a pleated sheet of material;

FIG. 6 is a three-dimensional view of a retainer including a retaining grid and a slotted opening, and a supplementary filter medium being inserted into position through the slotted opening, as an alternative to the retainer and supplementary filter medium of FIG. 1;

FIG. 7 is a three-dimensional view of a retainer including a retaining grid and a slotted opening, and a supplementary filter element including a pleated supplementary filter medium being inserted into position through the slotted opening, as an alternative to the retainer and supplementary filter element of FIG. 3;

FIG. 8 is a side elevational view, with a portion cut away to show an internal cross section, of a supplementary filter medium and a retainer therefor in combination with a conventional air particulate filter element in a filter mount within a representative part of an HVAC system, as an alternative to the HVAC system of FIG. 1; and

FIG. 9 is a cross-sectional view of one embodiment of a supplementary filter including a supplementary filter element and an attached frame-like planar flange; and

FIG. 10 is a cross-sectional view of another embodiment of a supplementary filter including a supplementary filter element and an attached frame-like planar flange.

### DETAILED DESCRIPTION

As described in detail hereinbelow, embodiments of the invention facilitate the use of supplementary filters, such as activated carbon filters for removing odors, in combination with conventional air particulate filters in an existing HVAC system, without modification to the HVAC system.

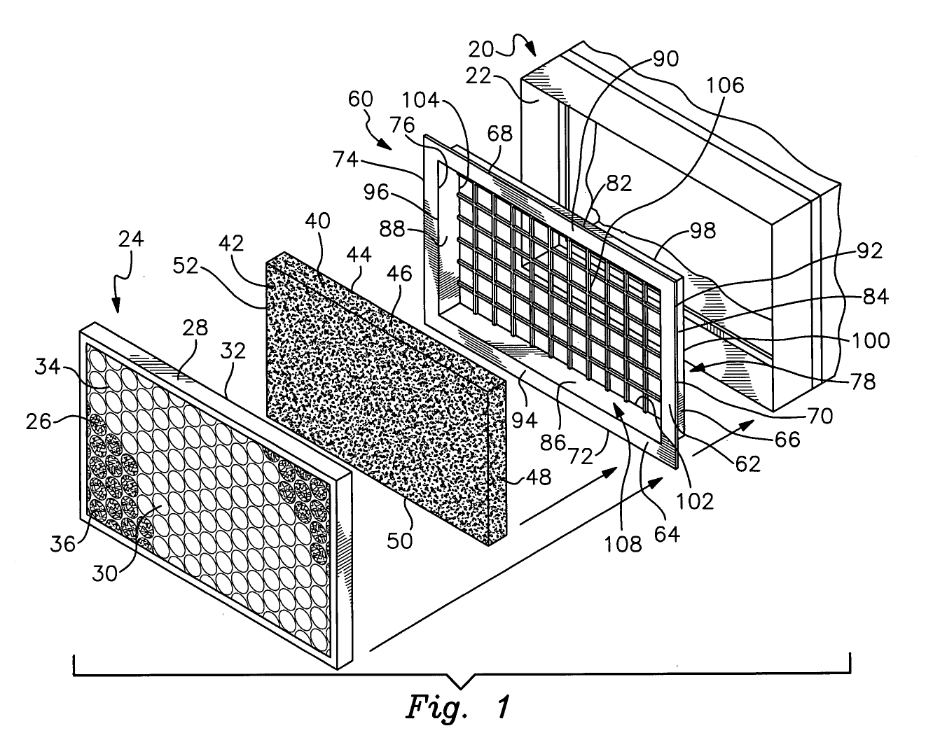

Referring first to the exploded three-dimensional view of FIG. 1, a structure 20 is representative of a forced-air HVAC system, and includes a representation 22 of a filter mount 22 of an HVAC system. The representative structure 20 including the filter mount 22 may be the air return portion of an air handler including heating and/or cooling elements (not shown), or may be the end of an air return duct remotely located from an air handler, as examples. A typical return air intake opening in which an air filter is installed has inwardly-projecting sheet metal or plastic flanges around the entire periphery of the opening. The flanges lie in a common plane and are set back from the opening a distance corresponding to the thickness of a conventional air particulate filter. In any event, air flow is drawn into the representative structure 20.

Although the acronym HVAC conventionally refers to heating, ventilation and air conditioning system, it will be appreciated that not all such forced-air systems which employ filters include all three elements. Thus, a system may provide forced-air heating, with or without outside ventilation, but no air conditioning. Likewise, a system may provide air conditioning, with or without outside air ventilation, but no heating. Accordingly, it will be appreciated that embodiments of the invention are employed within forced-air heating and/or ventilation and/or air conditioning systems.

The FIG. 1 filter mount 22 is designed to hold and retain a conventional air particulate filter element 24 of the type which is rectangular and nominally one inch in thickness. The conventional air particulate filter element 24 shown in FIG. 1 is representative and includes a filter medium 26 in the form of a glass fiber mat 26 and a paperboard frame 28 which is U-shaped in cross section and which forms the periphery of the filter element 24 as a support structure. The filter element 24 has an upstream side 30 and a downstream side 32. During operation, the filter medium 26 removes particulates from an air stream drawn into the representative structure 20. In the exemplary filter element 24 of FIG. 1, in order to retain the glass fiber mat filter medium 26, support grids are provided on the upstream and downstream sides 30 and 32. In FIG. 1, a metal support grid 34 on the upstream side 30 is visible, in the form of a thin metal sheet 34 with circular apertures 36 through which air flow passes, as is well known. The support grids exemplified by the support grid 34 are adhesively attached to the paperboard frame 28.

Positioned immediately downstream of the conventional air particulate filter element 24 is a supplementary filter medium 40 for removing odors from the air stream drawn into the representative structure 20. Such a supplementary filter medium 40 typically comprises activated carbon, which functions to adsorb or absorb odors from the air. In the embodiment of FIG. 1, the supplementary filter medium 40 comprises a porous (open cell) foam support structure, with activated carbon particles bonded to surfaces of the foam material. Such so-called activated carbon filters are commercially available.

The supplementary filter medium 40 is similar in shape to the conventional air particulate filter element 24, and thus is formed to fit within a hexahedral volume defined by two opposed major sides 42 and 44 of the filter medium 40 and four edge sides 46, 48, 50 and 52 establishing a thickness of the hexahedral volume. Accordingly, the supplementary filter medium 40 comprises a porous body within the hexahedral volume. The major side 42 corresponds to an upstream side 42 of the supplementary filter medium 40, and the major side 44 corresponds to the downstream side 44 of the supplementary filter medium 40.

For retaining the supplementary filter medium 40 in place, a retainer 60 is provided. The retainer 60 includes a frame-like planar flange 62 having an upstream side 64 and a downstream side 66. The frame-like planar flange 62 has four outer edges 68, 70, 72 and 74 defining a rectangle sized to match the rectangular conventional air particulate filter element 24, and the flange 62 defines a central opening 76 for air flow. The retainer 60 includes a retaining structure, generally designated 78, for the supplementary filter medium 40. The retaining structure 78 extends from the downstream side 66 of the frame-like planar flange 62 adjacent the opening 76.

Although in the FIG. 1 embodiment the supplementary filter medium 40 has a thickness comparable to the thickness of the conventional air particulate filter element 24, there is no particular requirement that the supplementary filter medium 40 have the same thickness. By way of example and without limitation, the supplementary filter medium 40 can range in thickness from one-quarter inch to four inches, selected in view of air flow and odor removal characteristics desired. The rectangular dimensions of the supplementary filter medium 40 are slightly smaller than the rectangular dimensions of the conventional air particulate filter element 24, since the rectangular dimensions of the supplementary filter medium 40 generally correspond to the size of the central opening 76 defined by the planar flange 62.

The upstream side 64 of the frame-like planar flange 62 is positionable facing the downstream side 32 of the conventional air particulate filter element 24 when positioned or installed within the filter mount 22. During use, the conventional air particulate filter element 24 and the supplementary filter medium 40 and retainer 60 in combination are assembled in a sandwich-like configuration having rectangular dimensions substantially identical to that of the conventional air particulate filter element 24, but an increased thickness which is accommodated within available space within the HVAC system represented by the structure 20. However, it is the combined thickness of the conventional air particulate filter element 24 and the planar flange 62 only of the retainer 60 which is required to be accommodated by the filter mount 22, and not the entire thickness of the supplementary filter medium 40. In most HVAC systems designed to hold a conventional air particulate filter element nominally one inch in thickness, there is a sufficient dimensional tolerance which, in addition, accommodates the thickness of the frame-like planar flange 62. Most of the retaining structure 78 remains clear of the filter mount 22.

Accordingly, it will be appreciated that the retainer 60 allows the supplementary filter medium 40 to be used in combination with existing conventional air particulate filter elements such as the filter element 24 within a standard HVAC system represented by the structure 22, without any modifications to the filter mount 22 portion of the HVAC system.

In the embodiment of FIG. 1, the retaining structure 78 more particularly includes four sidewall segments 82, 84, 86 and 88 extending perpendicularly to the frame-like planar flange 62 adjacent the opening 76. The sidewall segments 82, 84, 86 and 88 include corresponding upstream edges 90, 92, 94 and 96 attached to the frame-like planar flange 62, and corresponding distal downstream edges 98, 100, 102 and 104.

The FIG. 1 retaining structure 78 additionally includes a retaining grid 106 attached to the distal downstream edges 98, 100, 102 and 104 of at least some of the sidewall segments 82, 84, 86 and 88. The sidewall segments 82, 84, 86 and 88 and the retaining grid 106 accordingly together define at least a partial cavity-like structure for receiving and retaining the supplementary filter medium 40 in position against downstream forces. No retainer is required for the upstream side 42 of the supplementary filter medium 40 because, when assembled in the sandwich-like configuration, the supplementary filter medium 40 is retained in position against possible upstream forces (such as gravity at times when there is no air flow) by the downstream side 32 of the conventional air particulate filter element 24.

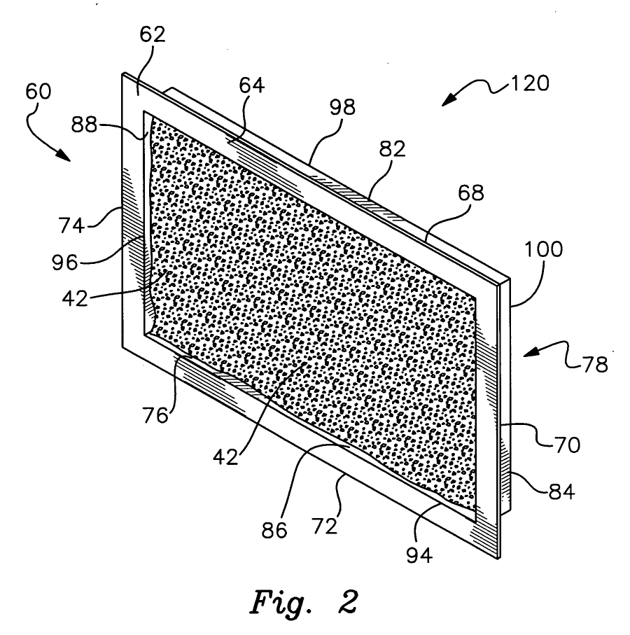

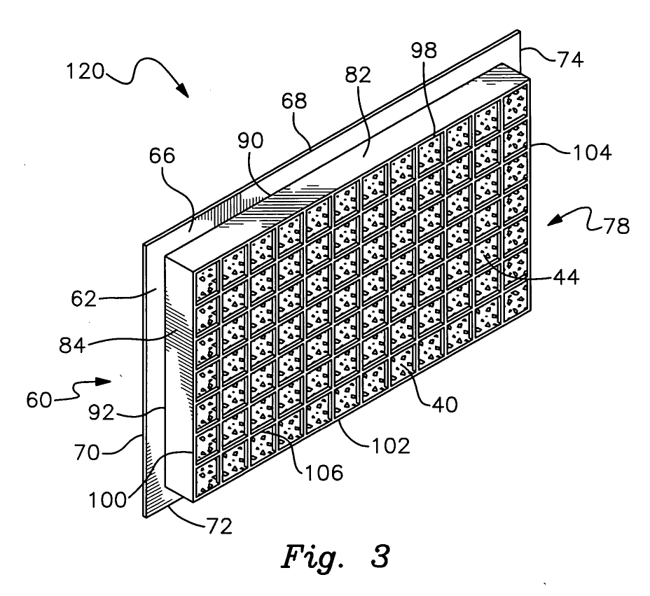

FIGS. 2 and 3 show what may be viewed as or termed a supplementary filter 120 for use within the filter mount 22 of the forced-air heating and/or ventilation and/or air conditioning system represented by the structure 20. More particularly, FIG. 2 is a three-dimensional view of the supplementary filter medium 40 and retainer 60 therefor of FIG. 1 in isolation, viewed from the upstream side thereof, that is, from the upstream side 42 of the filter medium and the upstream side 64 of the frame-like planar flange 62. FIG. 3 is a corresponding three-dimensional view of the supplementary filter medium 40 and the retainer 60 therefor of FIG. 1 in isolation, viewed from the downstream side thereof, in particular, from the downstream side 44 of the filter medium 40 and the downstream side 66 of the frame-like planar flange 62.

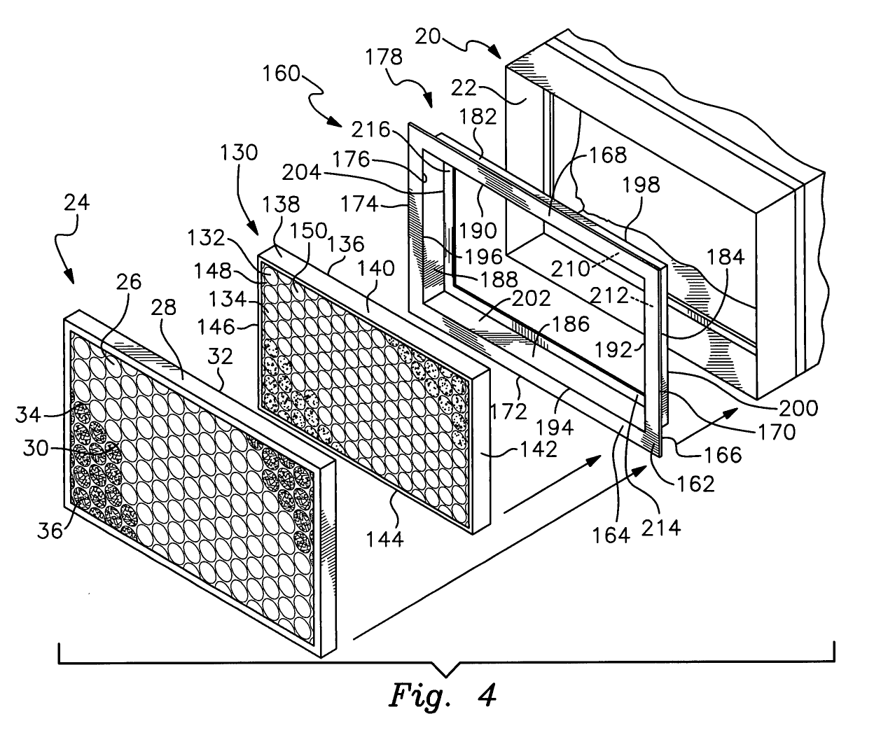

FIG. 4 is an exploded three-dimensional view similar to that of FIG. 1, but illustrating another embodiment of the invention. Conventional elements in FIG. 4 are identical to those of FIG. 1 and accordingly are not again described in detail. Those conventional elements in particular are the structure 20 representative of a forced-air HVAC system, including a representation 22 of a filter mount 22 of an HVAC system; and the conventional air particulate filter element 24.

Positioned immediately downstream of the conventional air particulate filter element 24 in FIG. 4 is a supplementary filter element 130 for removing odors from the air stream drawn into the representative structure 20. Except for the filter medium, the supplementary filter element 130 is similar in construction to the conventional air particulate filter element 24. More particularly, the supplementary filter element 130 includes a supplementary filter medium 132 which, like the supplementary filter medium 40 of FIGS. 1-3, typically comprises activated carbon, which functions to adsorb or absorb odors from an air stream drawn into the representative structure 20. In the embodiment of FIG. 4, the supplementary filter medium 132 comprises a porous (open cell) foam support structure, with activated carbon filters bonded to surfaces of the foam material. The supplementary filter element 130 has an upstream side 134 and a downstream side 136.

In addition to the supplementary filter medium 132, the FIG. 4 supplementary filter element 130 includes a paperboard frame 138 which forms the periphery of the supplementary filter element 130 as a support structure. The paperboard frame 138 is U-shaped in cross section, and is similar in construction to the paperboard frame 28 of the conventional air particulate filter element 24. Again, the supplementary filter element 130 is similar in shape to the conventional air particulate filter element 24, but with slightly smaller rectangular dimensions. In addition to the upstream side 134 and downstream side 136, the supplementary filter element 130 has four edge sides 140, 142, 144 and 146, establishing the thickness of the supplementary filter element 130.

In order to retain the supplementary filter medium 132, support grids, shown as representative metal support grids, are provided on the upstream and downstream sides 134 and 136, and attached, such as by adhesive, to the paperboard frame 138, similar to the metal support grid 34 of the conventional air particulate filter element 24. In FIG. 4, a metal support grid 148 on the upstream side 134 is visible, in the form of a thin metal sheet 148 with circular apertures 150 through which air flow passes.

For retaining the supplementary filter element 130 including the supplementary filter medium 132 in place, a retainer 160 is provided. In the FIG. 4 embodiment, as in the retainer 60 of FIG. 1, the retainer 160 includes a frame-like planar flange 162 having an upstream side 164 and a downstream side 166. The frame-like planar flange 162 again has four outer edges 168, 170, 172 and 174 defining a rectangle sized to match the rectangular conventional air particulate filter element 24, and the flange 162 defines a central opening 176 for air flow. The retainer 160 includes a retaining structure, generally designated 178, for the supplementary filter element 130 including the supplementary filter medium 132. The retaining structure 178 extends from the downstream side 166 of the frame-like planar flange 162 adjacent the opening 176.

Although the supplementary filter element 130 has a thickness comparable to the thickness of the conventional air particulate filter element 24, there is no particular requirement that the supplementary filter element 130 have the same thickness. The rectangular dimensions of the supplementary filter element 130 are slightly smaller than the rectangular dimensions of the conventional air particulate filter element 24, since the rectangular dimensions of the supplementary filter element 130 generally correspond to the size of the central opening 176 defined by the planar flange 162.

In FIG. 4, the upstream side 164 of the frame-like planar flange 162 again is positionable facing the downstream side 32 of the conventional air particulate filter element 24 when positioned or installed within the filter mount 22. During use, the conventional air particulate filter element 24 and the supplementary filter element 130 and retainer 160 in combination are assembled in a sandwich-like configuration having rectangular dimensions substantially identical to that of the conventional air particulate filter element 24, but an increased thickness which is accommodated within available space within the HVAC system represented by the structure 20. However, it is the combined thickness of the conventional air particulate filter element 24 and the planar flange 162 only of the retainer 160 which is required to be accommodated by the filter mount 22, and not the entire thickness of the supplementary filter element 130. In most HVAC systems designed to hold a conventional air particulate filter element nominally one inch in thickness, there is a sufficient dimensional tolerance to, in addition, accommodate the thickness of the frame-like planar flange 162. Most of the retaining structure 178 remains clear of the filter mount 22.

In the embodiment of FIG. 4, the retaining structure 178 more particularly includes four sidewall segments 182, 184, 186 and 188 extending perpendicularly to the frame-like planar flange 162 adjacent the opening 176. The sidewall segments 182, 184, 186 and 188 include corresponding upstream edges 190, 192, 194 and 196 attached to the frame-like planar flange 162, and corresponding distal downstream edges 198, 200, 202 and 204.

Instead of the retaining grid 106 of the embodiment of FIG. 1, the FIG. 4 retaining structure 178 additionally includes inwardly-projecting flanges 210, 212, 214 and 216 attached to the distal downstream edges 198, 200, 202 and 204 of at least some of the sidewall segments 182, 184, 186 and 188. The sidewall segments 182, 184, 186 and 188 and the inwardly-projecting flanges 210, 212, 214 and 216 together define at least a partial cavity-like structure for receiving and retaining the supplementary filter element 130 including the supplementary filter medium 132 in position. The paperboard frame 138 of the supplementary filter element 130, and the metal support grids, such as the metal support grid 148, provide sufficient rigidity for the supplementary filter element such that the retaining grid 106 as part of the retaining structure 78 of FIG. 1 is not required.

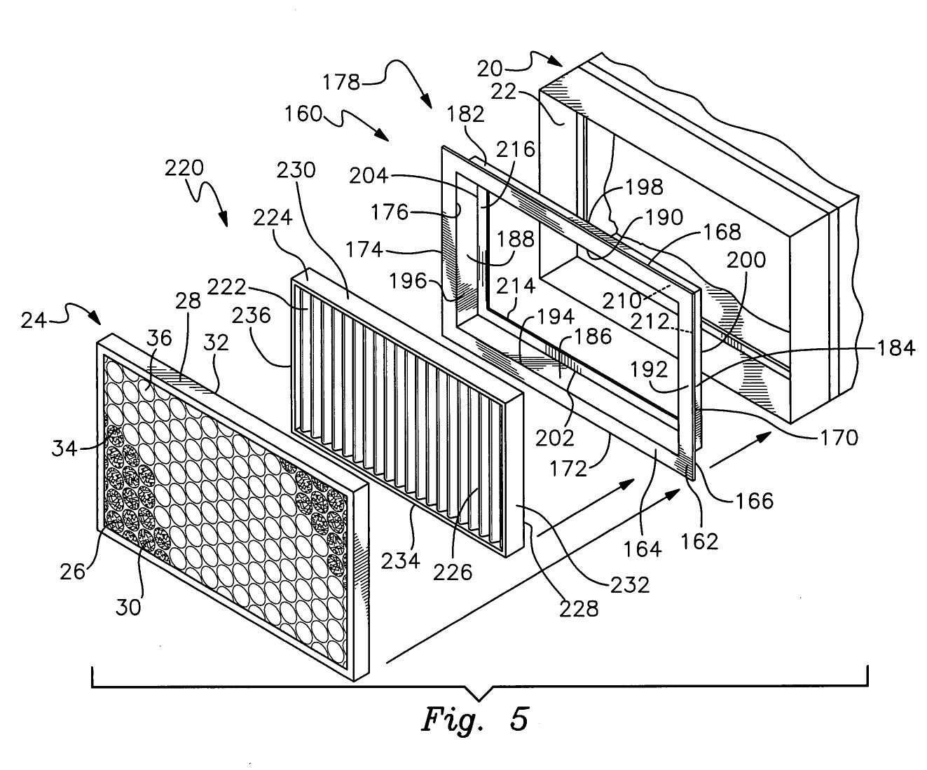

FIG. 5 illustrates yet another embodiment of the invention, nearly identical to that of FIG. 4. The FIG. 5 embodiment, instead of the supplementary filter element 130 of FIG. 4 including the supplementary filter medium 132 comprising a porous (open cell) foam support structure, employs a supplementary filter element 220 including a supplementary filter medium 222 comprising a pleated sheet 222 of material.

Again, conventional elements in FIG. 5 are identical to those of FIG. 1, and accordingly are not described in detail. Those conventional elements in particular are the structure 20 representative of a forced-air HVAC system, including a representation 22 of a filter mount 22 of an HVAC system; and the conventional air particulate filter element 24.

The supplementary filter element 220 including the supplementary filter medium 222 is positioned immediately downstream of the conventional air particulate filter element 24 in FIG. 5, and functions to remove odors from the air stream drawn into the representative structure 20. The supplementary filter medium 222 comprising a pleated sheet 222 of material is in part supported by a paperboard frame 224 which forms the periphery of the supplementary filter element 220 as a support structure. Again, the paperboard frame 224 is U-shaped in cross section, and is similar in construction to the paperboard frame 28 of the conventional air particulate filter element 24. The supplementary filter medium 222 more particularly is made of activated carbon particles bonded to a substrate of non-woven fibers. The pleated configuration, in addition to providing additional surface area, enhances the structural rigidity of the supplementary filter element 220. The supplementary filter element 220 is conventional in construction, and similar filter elements are commercially available, except that the rectangular dimensions required for the supplementary filter element 220 in embodiments of the invention are slightly smaller than standard filter element sizes. One example of a similar commercially-available filter element is an AmerSorb™ P activated carbon pleated panel filter sold by Precision Filtration Products, P.O. Box 218, Pennsburg, Pa. 18073 (www.precisionfiltration.com). Such activated carbon pleated panel filters are available in one-inch, two-inch, and four-inch thicknesses.

Again, the supplementary filter element 220 has an upstream side 226 and a downstream side 228, as well as four edge sides 230, 232, 234 and 236 establishing the thickness of the supplementary filter element 220.

For retaining the supplementary filter element 220 in place, in FIG. 5 the retainer 160 is employed as described hereinabove in detail with reference to FIG. 4. The retainer 160 includes the frame-like planar flange 162, as well as the retaining structure 178 in turn including inwardly-projecting flanges 210, 212, 214 and 216 attached to the distal downstream edges 198, 200, 202 and 204 of at least some of the sidewall segments 182, 184, 186 and 188.

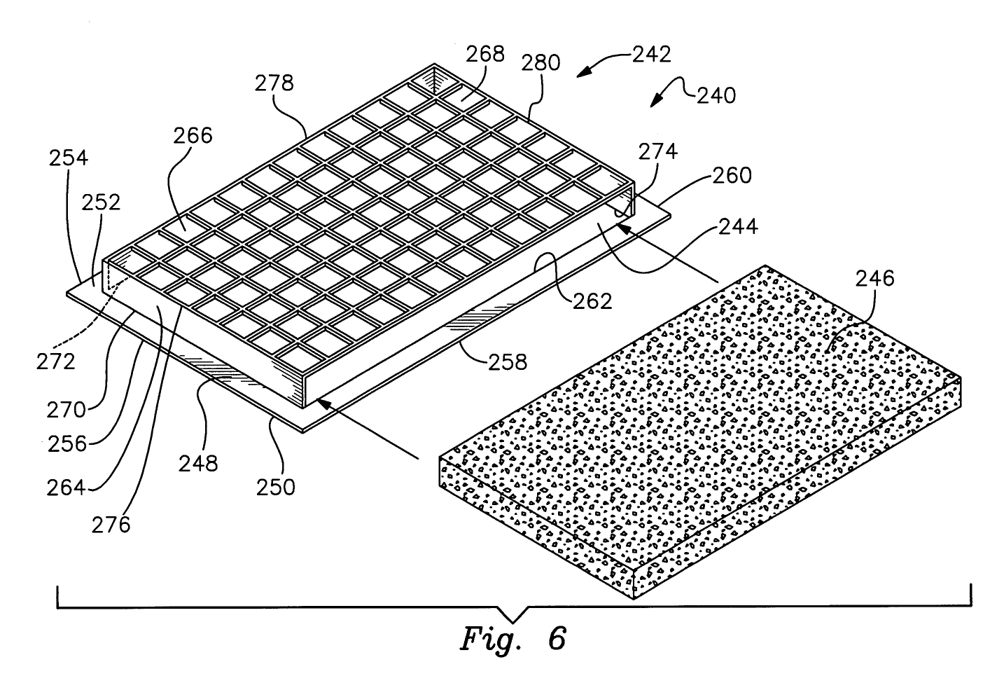

With reference now to FIG. 6, illustrated is a supplementary filter medium retainer 240 embodying the invention including a retaining structure generally designated 242, which defines an insertion slot 244 for a supplementary filter medium 246 for removing odors from an air stream drawer through the filter medium 246. The retainer 240 with filter medium 246 in place can be employed as an alternative to the retainer 60 and supplementary filter medium 40 of FIG. 1, as an alternative to the retainer 160 and supplementary filter element 130 of FIG. 4, or as an alternative to the retainer 160 and supplementary filter element 220 of FIG. 5 within the representative HVAC structure 20. The insertion slot 244 allows the supplementary filter medium 246 to be replaced, without opening up the sandwich-like construction of the retainer 240 against the conventional air particulate filter element 24.

As in the FIG. 1 embodiment, the retainer 240 of FIG. 6 includes a frame-like planar flange 248 having an upstream side 250 and a downstream side 252. The frame-like planar flange 248 has four outer edges 254, 256, 258 and 260 defining a rectangle sized to match the rectangular conventional air particulate filter element 24, and the flange 248 defines a central opening 262 for air flow. The retaining structure 242 extends from the downstream side 252 of the frame-like planar flange 248 adjacent the opening 262.

In the embodiment of FIG. 6, the retaining structure 242 includes three sidewall segments 264, 266 and 268 extending perpendicularly to the frame-like planar flange 248 adjacent the opening 262. The sidewall segments 264, 266 and 268 include corresponding upstream edges 270, 272 and 274 attached to the frame-like planar flange 248, and corresponding distal downstream edges 276, 278 and 280. There is no fourth sidewall segment, and the insertion slot 244 is defined at the location of the absent fourth sidewall segment. A retaining grid 282 is attached to the distal downstream edges 276, 278 and 280 of at least some of the sidewall segments 264, 266 and 268. In a manner comparable to the FIG. 1 embodiment, the sidewall segments 264, 266 and 268 and the retaining grid 282 together define at least a partial cavity-like structure for receiving and retaining the supplementary filter medium 246 in place against downstream forces. The FIG. 6 retaining structure 242 differs from the FIG. 1 retaining structure 78 primarily in that the insertion slot 244 is included.

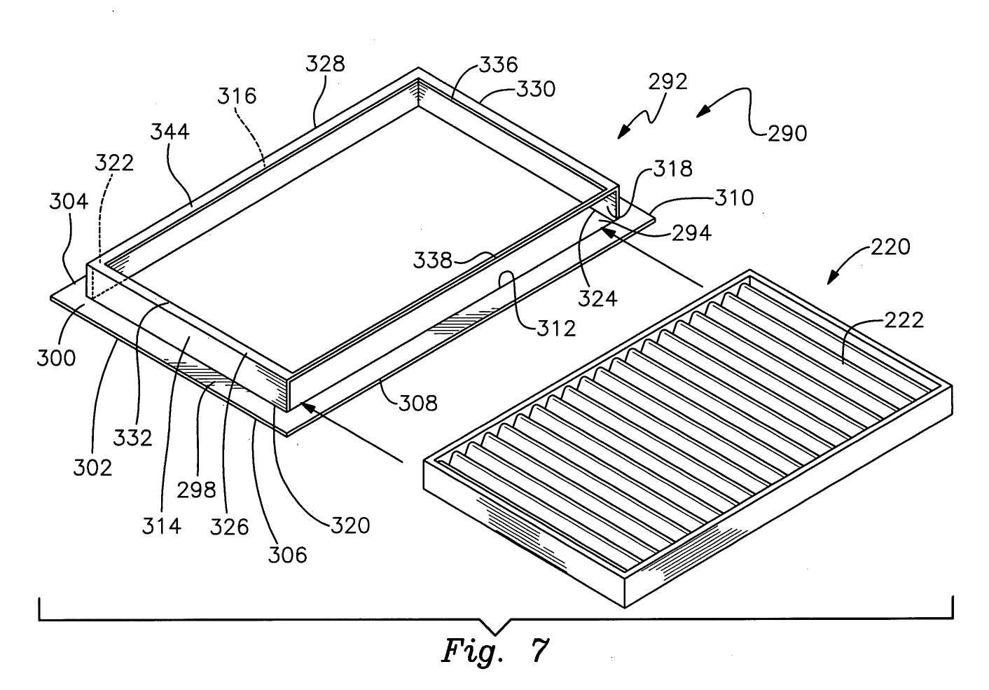

FIG. 7 illustrates another supplementary filter medium retainer 290 embodying the invention, for use in combination with the more rigid supplementary filter element 220 comprising the pleated supplementary filter medium 222 described hereinabove with reference to FIG. 5, as an example. The FIG. 7 retainer 290 includes a retaining structure generally designated 292, which defines an insertion slot 294 for the supplementary filter element 220 including the pleated secondary filter medium 222. The retainer 290 with supplementary filter element 220 in place can be employed as an alternative to the retainer 60 and supplementary filter medium 40 of FIG. 1, as an alternative to the retainer 160 and supplementary filter element 130 of FIG. 4, as an alternative to the retainer 160 and supplementary filter element 220 of FIG. 5, or as an alternative to the retainer 240 and supplementary filter medium 246 of FIG. 6 within the representative HVAC structure 20. The insertion slot 294 allows the supplementary filter element 220 to be replaced, without opening up the sandwich-like construction of the retainer 290 against the conventional air particulate filter element 24.

The retainer 290 of FIG. 7 includes a frame-like planar flange 298 having an upstream side 300 and a downstream side 302. The frame-like planar flange 298 has four outer edges 304, 306, 308 and 310 defining a rectangle sized to match the rectangular conventional air particulate filter element 24, and the flange 298 defines a central opening 312 for air flow. The retaining structure 292 extends from the downstream side 302 of the frame-like planar flange 298 adjacent the opening 312.

The FIG. 7 retaining structure 292 includes three sidewall segments 314, 316 and 318 extending perpendicularly to the frame-like planar flange 298 adjacent the opening 312. The sidewall segments 314, 316 and 318 include corresponding upstream edges 320, 322 and 324 attached to the frame-like planar flange 298, and corresponding distal downstream edges 326, 328 and 330. There is no fourth sidewall segment, and the insertion slot 294 is defined at the location of the absent fourth sidewall segment. Instead of the retaining grid 282 of the embodiment of FIG. 6, the FIG. 7 retaining structure 292 additionally includes inwardly-projecting flanges 332, 334 and 336 attached to the distal downstream edges 326, 328 and 330 of at least some of the sidewall segments 314, 316 and 318. In a manner comparable to that of the retaining structure 178 of FIGS. 4 and 5, in FIG. 7 the sidewall segments 314, 316 and 318 and the inwardly-projecting flanges 332, 334 and 336 together define at least a partial cavity-like structure for receiving and retaining the supplementary filter element 220 including the pleated supplementary filter medium 220 in position. To further support the filter element, a support bar 338 extends along the insertion slot 294.

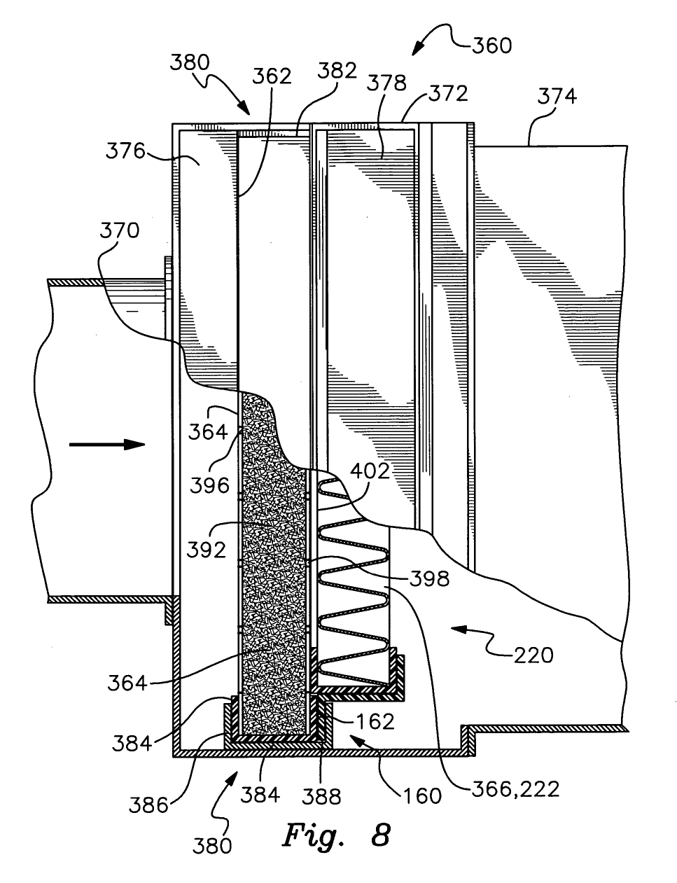

Referring now to FIG. 8, another structure 360 is representative of a forced-air HVAC system. FIG. 8 in particular illustrates how embodiments of the invention may be employed within an HVAC system structure 360 which has a slotted opening 362 which is sufficiently wide for insertion of a conventional air particulate filter element 364, but not wide enough to accommodate the combined thickness of the conventional air particulate filter element 364 and a supplementary filter medium 366 when assembled together in a sandwich-like configuration. The upper part of FIG. 8 is a side elevational view, which is broken away to show a cross section in the lower part of FIG. 8.

The FIG. 8 structure 360 includes a round air return duct 370, an air filter housing 372, and an air handler represented at 374 including heating and/or cooling elements (not shown). Air flow from the air return duct is drawn into the air handler 374. The air filter housing 372 accordingly in part serves as a transition between the air return duct 370 and the air handler 374.

The air filter housing 372 more particularly includes a side panel 376 within which the slotted opening 362 is formed. A hinged access door 378 is shown in its open position in FIG. 8. A filter mount 380 is provided within the air filter housing 372, in the form of upper and lower U-channels 382 and 384. In FIG. 8, the legs of the upper U-channel 382 are hidden behind the side panel 376, and only a portion of the upper U-channel 382 is visible through the open slotted opening 362. The lower U-channel 384 is shown in cross-section. Upstream and downstream legs 386 and 388 of the lower U-channel 384 are spaced a distance apart sufficient to accommodate a conventional air particulate filter element which is nominally one inch in thickness. However, typically there is a sufficient dimensional tolerance which, in addition, can accommodate the thickness of a frame-like planar flange which is part of embodiments of the invention, such as the frame-like planar flange 192.

The particular conventional air particulate filter element 364 represented in FIG. 8 by way of example includes a filter medium 392 in the form of a glass fiber mat 392 and a paperboard frame 394 which is U-shaped in cross section and which forms the periphery of the filter element 364 as a support structure. A conventional air particulate filter element employing a pleated filter (not shown) may as well be employed. In order to retain the glass fiber mat filter medium 392, support grids 396 and 398 are provided on upstream and downstream sides 400 and 402 of the conventional air particulate filter element 364.

The supplementary filter medium 366, by way of example, is identical to the supplementary filter medium 222 described hereinabove with reference to FIG. 5, and is part of the supplementary filter element 220 described hereinabove in detail with reference to FIG. 5. Also shown in FIG. 8 is the retainer 160, described hereinabove in detail with reference to FIG. 4.

Although the FIG. 8 slotted opening 362 is not wide enough to accommodate the combined thickness of the conventional air particulate filter element 364 and the supplementary filter element 366 when assembled together in a sandwich-like configuration, the two can separately be inserted through the slotted opening 362. During installation, the retainer 160 with the supplementary filter element 220 in place is inserted through the slotted opening 362, and is then shifted in a downstream direction (to the right in the FIG. 8 orientation) until the downstream side 166 of the frame-like planar flange 162 contacts the downstream legs of the U-channels 382 and 384, the downstream leg 388 of the lower U-channel being visible in FIG. 8. Sufficient clearance remains so that the conventional air particulate filter element 364 can be inserted through the same slotted opening 362, and the access door 378 closed. The process is reversed for removal.

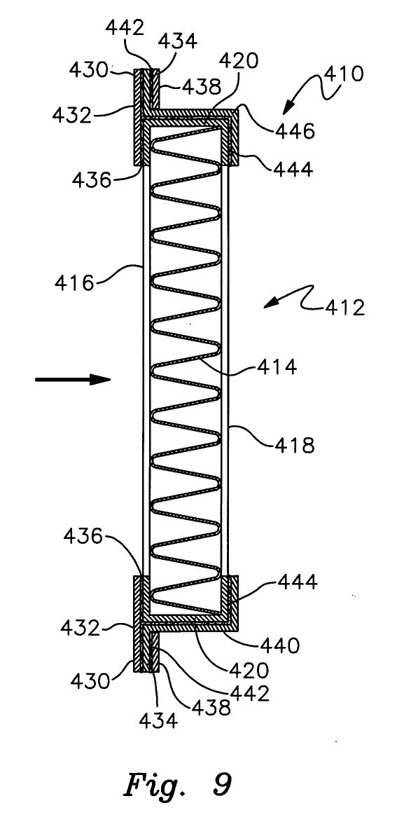

Referring next to FIG. 9, a supplementary filter 410 embodying the invention includes a supplementary filter element 412 essentially identical in construction to the supplementary filter element 220 of FIG. 5, including a supplementary filter medium 412 comprising a pleated sheet with activated carbon for removing odors. The supplementary filter element 412 has an upstream side 416 and a downstream side 418. The supplementary filter element 412 includes as a support structure a paperboard frame 420 which is U-shaped in cross section.

A frame-like planar flange 430 has an upstream side 432 and a downstream side 434, and is adhesively attached to the paperboard frame 420, as indicated by an adhesive layer 436. For additional structural strength, support members 438 and 440 are provided, likewise secured by adhesive layers 442 and 444. The frame-like planar flange 430, as well as the support members 438 and 440, may be made either of paperboard of plastic.

The pleated supplementary filter medium 414 is representative of other forms of supplementary filter medium as described hereinabove, and comprises a gas-adsorption or absorption filter. The supplementary filter medium 414 is thus representative of a supplementary filter medium in the form of a porous body within the hexahedral volume such as the supplementary filter medium 40 of FIG. 1.

The supplementary filter 410 of FIG. 9 differs from embodiments of the invention described hereinabove in that the frame-like planar flange 430 is permanently attached to the supplementary filter element 412. Thus the supplementary filter 410 is sold as a unit, and is intended to be disposed when the activated carbon is no longer effective. In use, however, the frame-like planar flange 430 functions in the same manner as in the embodiments described hereinabove, and the supplementary filter 410 is employed in combination with existing conventional air particulate filter elements such as the filter element 24 in either the HVAC system represented by the structure 20 of FIGS. 1, 4 and 5, or the HVAC system represented by the structure 360 of FIG. 8 as examples.

Thus, the upstream side 416 of the supplementary filter element 410 and the upstream side 430 of the frame-like planar flange 430 are positionable facing the downstream side of the conventional air particulate filter element, with the supplementary filter element 412 retained by the frame-like planar flange 430 within a filter mount.

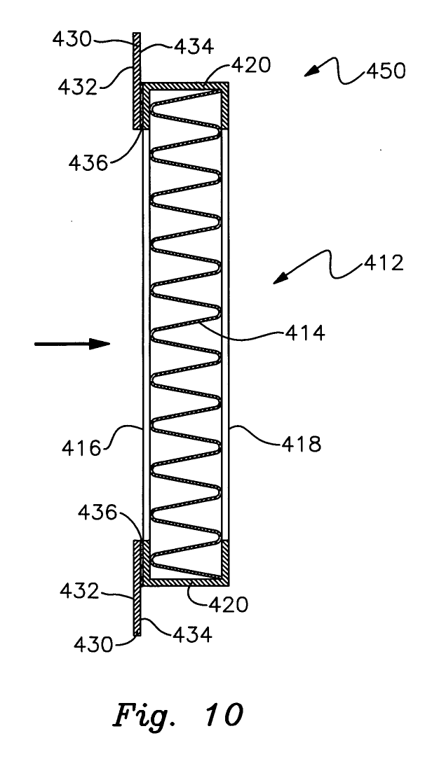

Referring finally to FIG. 10, illustrated is yet another embodiment of a supplementary filter 450, differing from the supplementary filter 410 of FIG. 9 only in that the support members 438 and 440 are not included. In some cases, sufficient structural rigidity is provided simply by adhesively attaching the frame-like planar flange 430 to the paperboard frame 420.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A retainer for a supplementary filter medium for use within a filter mount within a forced-air heating and/or ventilation and/or air conditioning system in combination with a conventional air particulate filter element of the type which is rectangular and which has an upstream side and a downstream side, said retainer comprising:
a frame-like planar flange having an upstream side and a downstream side, and having outer edges defining a rectangle sized to match the rectangular conventional air filter element, said frame-like planar flange defining a central opening for air flow; and
a retaining structure for the supplementary filter medium extending from said downstream side of said frame-like planar flange adjacent said opening;
said upstream side of said frame-like planar flange being positionable facing the downstream side of the conventional air particulate filter element within the filter mount.

2. The retainer of claim 1, wherein said retaining structure in turn comprises a plurality of sidewall segments extending perpendicularly to said flange adjacent said opening, each of said sidewall segments including an upstream edge attached to said flange, and a distal downstream edge.

3. The retainer of claim 2, wherein said retaining structure further comprises a retaining grid attached to said distal downstream edges of at least some of said sidewall segments, said sidewall segments and said retaining grid together defining at least a partial cavity-like structure for receiving and retaining the supplementary filter medium in position against downstream forces.

4. The retainer of claim 2, wherein said retaining structure further comprises inwardly-projecting flanges attached to said distal downstream edges of at least some of said sidewall segments, said sidewall segments and said inwardly-projecting flanges together defining at least a partial cavity-like structure for receiving and retaining the supplementary filter medium in position against downstream forces.

5. The retainer of claim 3, wherein:
said opening is rectangular, having four sides; and which retainer comprises:
three sidewall segments adjacent three corresponding sides of said opening, an insertion slot being defined along the fourth side of said opening between said flange and said retaining grid.

6. The retainer of claim 4, wherein:
said opening is rectangular, having four sides; and which retainer comprises:
three sidewall segments adjacent three corresponding sides of said opening, an insertion slot being defined along the fourth side of said opening between said flange and said inwardly-projecting flanges.

7. The retainer of claim 2, wherein:
said opening is rectangular, having four sides; and which retainer comprises:
four sidewall segments adjacent corresponding sides of said opening.

8. A supplementary filter for use within a filter mount within a forced-air heating and/or ventilation and/or air conditioning system in combination with a conventional air particulate filter element of the type which is rectangular and which has an upstream side and a downstream side, said supplementary filter comprising:
a supplementary filter medium formed to fit within a hexahedral volume defined by two opposed rectangular major sides and four edge sides establishing a thickness of the hexahedral volume, said supplementary filter medium having an upstream side and a downstream side;
a retainer for said supplementary filter medium, said retainer including
a frame-like planar flange having an upstream side and a downstream side, and having outer edges defining a rectangle sized to match the rectangular air particulate filter element, said frame-like planar flange defining a central opening for air flow, and
a retaining structure for said supplementary filter medium extending from said downstream side of said frame-like planar flange adjacent said opening; and
said upstream side of said supplementary filter medium and said upstream side of said frame-like planar flange being positionable facing the downstream side of the conventional air particulate filter element with said supplementary filter medium retained by said retainer within the filter mount.

9. The supplementary filter of claim 8, wherein said supplementary filter medium comprises a gas adsorption or absorption filter.

10. The supplementary filter of claim 8, wherein said supplementary filter medium comprises activated carbon.

11. The supplementary filter of claim 8, wherein said supplementary filter medium comprises a porous body within the hexahedral volume.

12. The supplementary filter of claim 8, wherein said supplementary filter medium comprises a pleated sheet of material.

13. The supplementary filter of claim 8, wherein said retaining structure of said retainer in turn comprises a plurality of sidewall segments extending perpendicularly to said flange adjacent said opening, each of said sidewall segments including an upstream edge attached to said flange, and a distal downstream edge.

14. The supplementary filter of claim 13, wherein said retaining structure further comprises a retaining grid attached to said distal downstream edges of at least some of said sidewall segments, said sidewall segments and said retaining grid together defining at least a partial cavity-like structure for receiving the supplementary filter medium in position against downstream forces.

15. The supplementary filter of claim 13, wherein said retaining structure further comprises inwardly-projecting flanges attached to said distal downstream edges of at least some of said sidewall segments, said sidewall segments and said inwardly-projecting flanges together defining at least a partial cavity-like structure for receiving and retaining the supplementary filter medium in position against downstream forces.

16. The supplementary filter of claim 14, wherein:
said opening is rectangular, having four sides; and which retainer comprises:
three sidewall segments adjacent three corresponding sides of said opening, an insertion slot being defined along the fourth side of said opening between said flange and said retaining grid.

17. The supplementary filter of claim 15, wherein:
said opening is rectangular, having four sides; and which retainer comprises:
three sidewall segments adjacent three corresponding sides of said opening, an insertion slot being defined along the fourth side of said opening between said flange and said inwardly-projecting flanges.

18. The supplementary filter of claim 13, wherein:
said opening is rectangular, having four sides; and which retainer comprises:
four sidewall segments adjacent corresponding sides of said opening.

19. A supplementary filter for use within a filter mount within a forced-air heating and/or ventilation and/or air conditioning system in combination with a conventional air particulate filter element of the type which is rectangular and which has an upstream side and a downstream side, said supplementary filter comprising:
a supplementary filter element including a supplementary filter medium formed to fit within a hexahedral volume defined by two opposed rectangular major sides and four edge sides establishing a thickness of the hexahedral volume, and
a frame forming the periphery of said supplementary filter element as a support structure, said supplementary filter element having an upstream side and a downstream side; and
a frame-like planar flange having an upstream side and a downstream side and attached to said frame generally on the upstream side of said supplementary filter element, said frame-like planar flange having outer edges defining a rectangle sized to match the rectangular air particulate filter element, and said frame-like planar flange defining a central opening for air flow;
said upstream side of said supplementary filter element and said upstream side of said frame-like planar flange being positionable facing the downstream side of the conventional air particulate filter element with said supplementary filter element retained by said frame-like planar flange within the filter mount.

20. The supplementary filter of claim 19, wherein said supplementary filter medium comprises a gas adsorption or absorption filter.

21. The supplementary filter of claim 19, wherein said supplementary filter medium comprises activated carbon.

22. The supplementary filter of claim 19, wherein said supplementary filter medium comprises a porous body within the hexahedral volume.

23. The supplementary filter of claim 19, wherein said supplementary filter medium comprises a pleated sheet of material.
